(19) United States
(12) Patent Application Publication
(10) Pub. No.: US 2008/0127078 A1
(43) Pub. Date: May 29, 2008

(54) Method and apparatus for preventing modulation of executable program

(75) Inventors: Su-hyun Nam, Seoul (KR); Sang-su Choi, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/647,188

(22) Filed: Dec. 29, 2006

(30) Foreign Application Priority Data
Aug. 25, 2006 (KR) 10-2006-0081177

(51) Int. Cl. G06F 9/44

(52) U.S. Cl. 717/120

(57) ABSTRACT

A method and apparatus for preventing modulation of an executable program are provided. The method includes decoding a header of the executable program and generating information about a plurality of executable codes, grouping the plurality of executable codes into a first code group and a second code group with reference to the information about the plurality of executable codes, matching each of the plurality of executable codes included in the first code group with each of the plurality of executable codes included in the second code group, and encoding each of the corresponding executable codes included in the second code group using each hash value of the executable codes included in the first code group.

### CROSS-REFERENCE TO RELATED PATENT APPLICATION

This application claims priority from Korean Patent Application No. 10-2006-0081177, filed on Aug. 25, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to preventing modulation of a software file, and more particularly, to a software module which can directly/indirectly prevent tampering with data by an outside source while running code corresponding to a binary executable code, and a method therefor.

2. Description of the Related Art

As technologies used to code programs improve, software content becomes more greatly exposed to various unauthorized access threats by hackers, who are illegal users having ill-intentions, such as changing a software structure or incapacitating a technical protective measure, etc.

In other words, hackers can hack into computers or terminals using content applied with digital rights management (DRM) in order to tamper or delete executable code.

Software hacking technology incapacitates technical protective measures of the DRM through inverse analysis and debugging. For example, a DRM that has been set up can be destroyed by using a debugging tool, such as SoftIce, W32dasm, or the like, a registry monitoring tool, a file monitoring tool, etc.

Also, because of tampering, which manipulates time and data, a time of a computer or a terminal can be intentionally changed, or a usage count or details of usage of content that exceeds a permitted usage count can be manipulated so as to intentionally use content that exceeds the terms of validity.

The latest software is designed and realized in modular form, and thus expandability and integrity are excellent. However, these modules are called and exchange messages through an interface, and so a fraudulent module can be disguised as a normal module in order to manipulate a program or steal important data.

Also, DRM technology controls permitted users to use content according to their permitted usage rights. However, there may be weak points in security due to various data exchanges in an application or computer management system. For example, tampering can be attempted through an abnormal data leakage path, such as data copying through copy&paste, drag&drop, clipboard, data copying through screen capture using print screen and various other capture utilities, etc.

Conventionally, in order to prevent tampering, a program is verified to check whether it has been illegally changed by the hacker. Generally, tampering prevention technology is classified into a method of inserting a scramble code at a source level and a method of detecting and intercepting a hacking attempt in a management system. The method of inserting a scramble code at a source level increases the difficulty of performing debugging since it involves inserting a dummy code into a module which performs an important logic function in the program. The method of detecting and intercepting a hacking attempt in a management system involves detecting at a system level when a program that can be used for hacking is executed, and stopping the hacking program or the program that is to be protected.

However, there are various kinds of software hacking tools, and some software tracking tools include a function of detouring the method of detecting and intercepting a hacking attempt in a management system. Accordingly, a more fundamental tampering prevention technology is required.

### SUMMARY OF THE INVENTION

The present invention provides a method of preventing tampering with a program which is stored in a hard disk before the program is executed and when the program is being executed.

According to an aspect of the present invention, there is provided a method of preventing modulation of an executable program, the method including: decoding a header of the executable program and calculating information about a plurality of executable codes; grouping the plurality of executable codes into a first code group and a second code group with reference to the information about the plurality of executable codes; matching each of the executable codes included in the first code group with respective executable codes included in the second code group; and encoding each of the matched executable codes included in the second code group using a first hash value of each of the plurality of executable codes included in the first code group.

The method may further include: decoding each of the matched executable codes included in the second code group using the first hash value of each of the plurality of executable codes included in the first code group; and encoding the corresponding executable codes included in the first code group using each hash value of the plurality of executable codes included in the second code group.

The method may further include changing symbol string data of a header of the executable program.

The plurality of executable codes included in the first code group and the plurality of executable codes included in the second code group may correspond one-to-one.

The executable codes included in the first code group may be executable codes which are to be protected.

According to another aspect of the present invention, there is provided a method of preventing modulation of an executable program, the method including: decoding a header of the executable program and calculating information about a plurality of executable codes; sorting the plurality of executable codes into a first code group, formed of encoded executable codes, and a second code group, formed of unencoded executable codes, with reference to the information about the plurality of executable codes; matching each of the plurality of executable codes included in the first code group with each of the plurality of executable codes included in the second code group; decoding a first executable code, which is to be executed, from among the plurality of executable codes included in the first code group, using a hash value of a second executable code corresponding to the first executable code; and encoding the first executable code using the hash value of the second executable code, after the decoded first executable code has been executed.

At least one executable code included in the first code group, excluding the first executable code, may be encoded using a hash value of a corresponding executable code included in the second code group, while the first executable code is being executed.

The second executable code may be included in the second code group.

The plurality of executable codes included in the first code group and the plurality of executable codes included in the second code group may correspond one-to-one.

According to another aspect of the present invention, there is provided an apparatus for preventing modulation of an executable program, the apparatus including: a parsing unit which decodes a header of the executable program and calculates information about a plurality of executable codes; a sorting unit which groups the executable codes into a first code group and a second code group with reference to the information about the executable codes; a matching unit which matches each of the executable codes included in the first code group with respective executable codes included in the second code group; and an encoder and decoder which encodes each of the corresponding executable codes included in the second code group using each hash value of the plurality of executable codes included in the first code group.

According to another aspect of the present invention, there is provided an apparatus for preventing modulation of an executable program, the apparatus including: a parsing unit which decodes a header of the executable program and calculates information about a plurality of executable codes; a sorting unit which groups the executable codes into a first code group, formed of encoded executable codes, and a second code group, formed of unencoded executable codes, with reference to the information about the plurality of executable codes; a matching unit which matches each of the plurality of executable codes included in the first code group with respective executable codes included in the second code group; and an encoder and decoder which decodes a first executable code, which is to be executed, from among the plurality of executable codes included in the first code group, using a hash value of a second executable code corresponding to the first executable code, and encodes the first executable code using the hash value of the second executable code, after the decoded first executable code has been executed.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram illustrating a tampering prevention module 100 according to an exemplary embodiment of the present invention;

FIG. 2 is a flowchart illustrating a method of preventing tampering before a program is executed, according to an exemplary embodiment of the present invention;

FIGS. 3A through 3C are diagrams illustrating a transformation process of the program of FIG. 2;

FIG. 4 is a diagram illustrating an encoder and decoder 150 encoding a link set using a hash value of a protection set according to an exemplary embodiment of the present invention;

FIG. 5 is a flowchart illustrating a method of preventing tampering while a program is being executed, according to an exemplary embodiment of the present invention;

FIG. 6 is a diagram illustrating a transformation process of a program when the program is loaded in a memory of a peripheral device according to FIG. 5; and

FIGS. 7A through 7C are diagrams illustrating a transformation process of the program of FIG. 5 while the program is being executed.

### DETAILED DESCRIPTION OF THE EXEMPLARY EMBODIMENTS OF THE INVENTION

Hereinafter, the present invention will be described more fully with reference to the accompanying drawings, in which exemplary embodiments of the invention are shown.

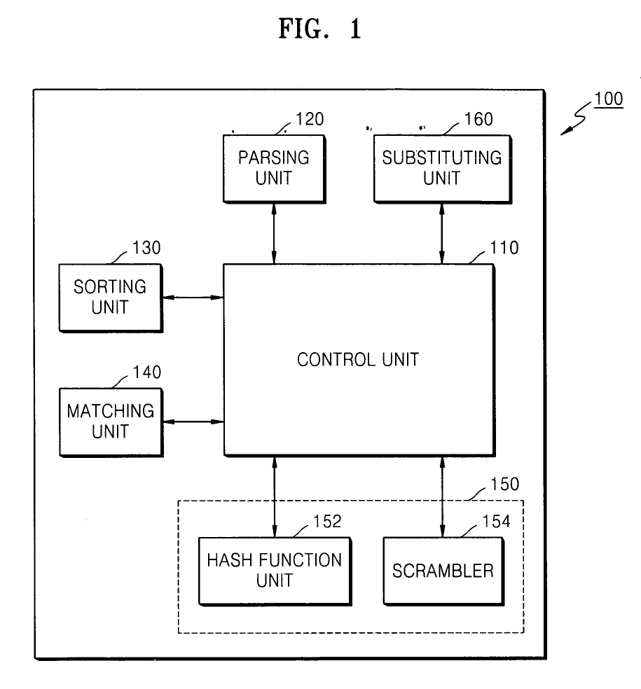

FIG. 1 is a block diagram illustrating a tampering prevention module 100 according to an exemplary embodiment of the present invention.

The tampering prevention module 100 includes a control unit 110, a parsing unit 120, a sorting unit 130, a matching unit 140, an encoder and decoder 150, and a substituting unit 160.

First, the control unit 110 controls overall processes by linking with each unit of the tampering prevention module 100. The parsing unit 120 extracts information about binary executable codes by parsing a header of a program.

The sorting unit 130 sorts the binary executable codes into a protection set and a link set. The link set includes a plurality of plain text programming commands, which realizes various non-sensitive services, from among the binary executable codes. The protection set includes various groups, such as plain texts of programming commands, which realize various sensitive services, obfuscated cells, etc. Accordingly, a group which realizes a sensitive service or a service that requires protection is sorted as the protection set. Here, the binary executable codes do not necessarily have to be sorted into two sets by the sorting unit 130, but may be sorted into three or more sets, including a common set that does not have any function.

The matching unit 140 generates and manages a correlation between the selected two sets. That is, a plurality of executable codes included in the protection set and a plurality of executable codes included in the link set correspond one-to-one.

The encoder and decoder 150 include a hash function unit 152 and a scrambler 154. The hash function unit 152 generates a hash value using a hash function and the scrambler 154 encodes or decodes the binary executable codes based on the generated hash value.

The substituting unit 160 randomly arranges or changes symbol string data of a header of the program so that the symbol string data becomes meaningless.

Hereinafter, a method of preventing tampering before a program stored in a hard disk is executed will be described. Also a method of preventing tampering when the program is being executed will be described.

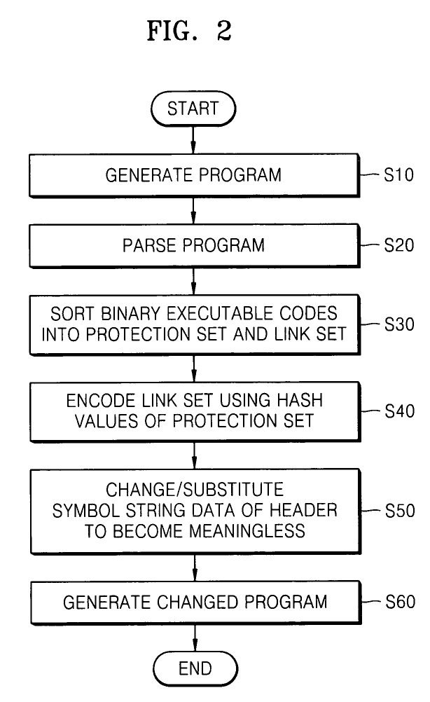

First, the method of preventing tampering before the program is executed, which is used by the tampering prevention module 100 of FIG. 1, will be described with reference to FIGS. 2 through 4.

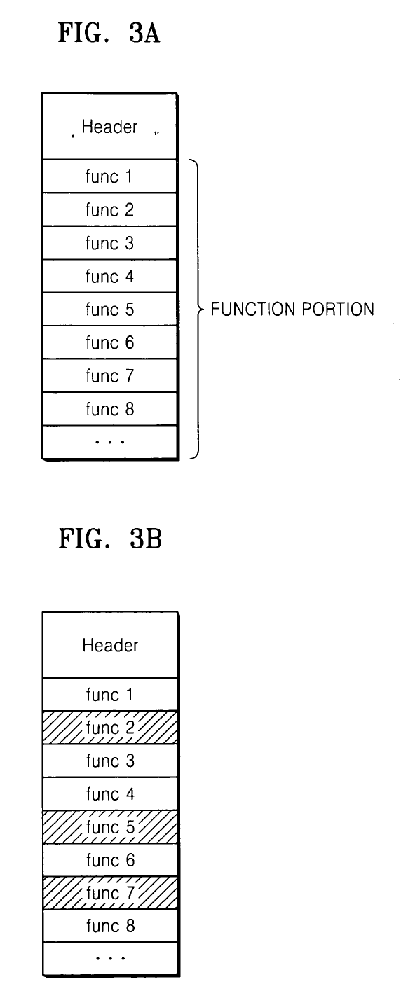

FIG. 2 is a flowchart illustrating the method of preventing tampering before the program is executed, according to an exemplary embodiment of the present invention, and FIGS. 3A through 3C are diagrams illustrating a transformation process of the program of FIG. 2. The program is assumed to be stored in a disk before it is executed.

First, an executable program, formed of a header and a function portion as illustrated in FIG. 3A, is generated in operation S10. The header includes header information, such as symbol string data of functions for performing debugging, the position of functions, etc. The function portion includes various functions, for example, func1, func2, . . . , func8, and so on, which are expressed as binary executable codes.

Then, the parsing unit 120 parses the executable program in operation S20, in order to obtain information about the binary executable codes recorded in the header.

The sorting unit 130 sorts each of the binary executable codes into the protection set and the link set, from among the function portions in operation S30. As described above, the protection set includes binary executable codes which realize a sensitive service or a service that requires protection, and the link set includes binary executable codes which realize non-sensitive service. Here, the protection set and the link set can be sorted using a coder, and the sorting unit 130 stores information about the binary executable codes corresponding to the sorted protection set and the link set. For convenience of description, it is assumed that the functions func2, func5, and func7 are the binary executable codes included in the protection set and the functions func1, func3, and func6 are the binary executable codes included in the link set in FIG. 3B.

The matching unit 140 arbitrarily matches the functions func2, func5, and func7 included in the protection set with the functions func1, func3, and func6 included in the link set, and the encoder and decoder 150 encodes the corresponding functions func1, func3, and func6 included in the link set using hash values of the functions func2, func5, and func7 included in the protection set in operation S40. In the current exemplary embodiment, function func2, matches function func1, function func5 matches function func6, and function func7 matches function func3.

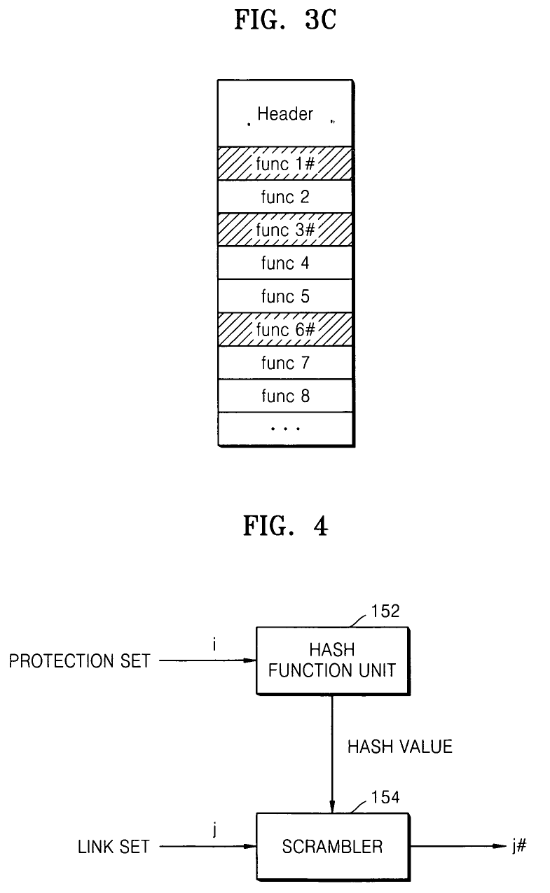

FIG. 4 is a diagram illustrating the encoder and decoder 150 of FIG. 1 encoding the link set using hash values of the protection set according to an exemplary embodiment of the present invention.

As shown in FIG. 4, when the binary executable codes i included in the protection set are input into the hash function unit 152, the hash value is generated and output to the scrambler 154. Also, when the binary executable codes j included in the link set are input into the scrambler 154, the scrambler 154 encodes the binary executable codes j using the input hash value and outputs the newly encoded binary executable codes j#.

When the input binary executable codes i are changed, the output binary executable codes j# are changed. Accordingly, when a hacker changes the program, hash values of functions including the changed portion also change. The changed hash values are used to decode other functions corresponding to the functions including the changed portion. Since the changed hash values are different from the hash values used in encoding the other functions, the program is unable to execute normally.

In this manner, as shown in FIG. 3C, an encoded function func1# is generated using the function func2, an encoded function func6# is generated using the function func5, and an encoded function func3# is generated using the function func7.

Accordingly, by encoding the binary executable codes of the program stored in the disk before the program is executed, the hacker cannot execute the program normally.

Conventionally, before a program stored in a hard disk is executed, hackers use a “disassembler” in order to attempt hacking by changing the binary executable codes, which are machine codes, into an assembly language, and tracking the assembly language. Accordingly, by encoding part of the binary executable codes stored in the disk, the hacker cannot normally execute an original program as shown in FIG. 3A.

Meanwhile, the substituting unit 160 may arbitrarily change or substitute symbol string data of the header of the program meaninglessly in operation S50 of FIG. 2 so as to transmit wrong information to the hacker. That is, by changing position information and the title of the functions recorded in the header, the hacker cannot normally execute or change the program.

As described above, by encoding the binary executable codes of the original program of FIG. 3A before the program is executed, a changed program as shown in FIG. 3C is generated in operation S60 of FIG. 2. Thus, the hacker cannot use the original program normally or change the program.

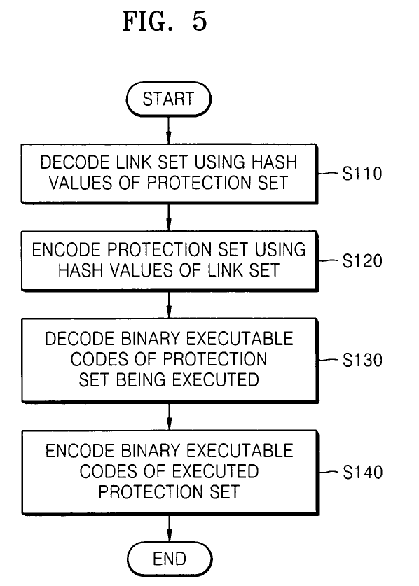

Hereinafter, a method of preventing tampering while a program is being executed, which is used by the tampering prevention module 100 of FIG. 1, will be described with reference to FIGS. 5 through 7C.

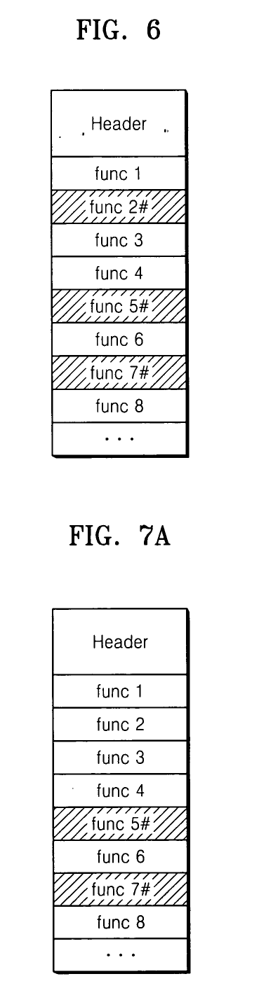

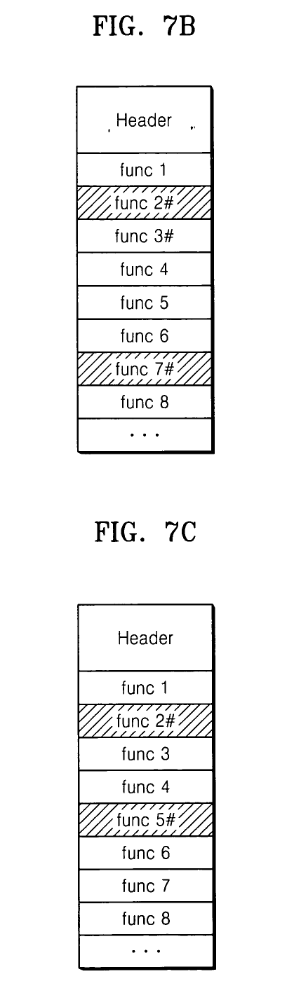

FIG. 5 is a flowchart illustrating a method of preventing tampering while the program is being executed, according to an exemplary embodiment of the present invention, FIG. 6 is a diagram illustrating a transformation process of the program when the program is loaded in a memory of a peripheral device according to FIG. 5, and FIGS. 7A through 7C are diagrams illustrating a transformation process of the program of FIG. 5 while the program is being executed.

First, while the functions included in the link set as shown in FIG. 3C are encoded, the corresponding functions included in the link set are decoded using hash values of functions included in the protection set in operation S110. A process of decoding the link set using the hash values of the protection set is the same as the process of encoding the link set using the hash values of the protection set as illustrated in FIG. 4. Accordingly, a detailed description thereof will be omitted.

After decoding the corresponding link set using the hash values of the protection set using the method shown in FIG. 4, the corresponding protection set is encoded using hash values of the link set in operation S120. Accordingly, after encoding the corresponding functions included in the protection set using each hash value of the respective functions included in the link set, the program is uploaded in the memory of the peripheral device shown in FIG. 6.

As described above, by encoding the binary executable codes included in the protection set, dumping, whereby a hacker sequentially reads the uploaded binary executable codes in the memory, can be prevented.

Next, executing the program uploaded in the memory as illustrated in FIG. 6 will be described.

Generally, functions whose addresses are indicated in the header are sequentially executed from among the programs uploaded in the memory. In the current exemplary embodiment, it is assumed that the functions are sequentially executed starting from the function func1.

When the control unit 110 generates a command for executing the program uploaded in the memory, the binary executable codes in the protection set, which are to be executed, are decoded in operation S130.

That is, after the function func1 is executed, the encoded function func2# should be executed. Accordingly, only function func2# is decoded into function func2 in order to be executed as shown in FIG. 7A, from among the encoded functions func#2, func5#, and func7# as shown in FIG. 6. Then, after the function func2 is executed, the executed function func2 is again encoded into the function func2#. When the function func5# is decoded into function func5 as shown in FIG. 7B, the function func2# and the function func8# stay encoded.

That is, the binary executable codes of the executed protection set are again encoded in operation S140, so that the program does not have the same format as the original program of FIG. 3A, while the program is executed.

In the same manner, after the function func5# is decoded and then executed as function func5, the function func5 is again encoded into the function func5#, and while the function func8# is decoded into the function func8 as shown in FIG. 7C, the function func2# and the function func5# are maintained encoded.

Accordingly, by maintaining at least one binary executable code encoded from among the plurality of binary executable codes, while uploading the program to the memory of the peripheral device and executing the program, the hacker is unable to hack the program.

In the method of preventing tampering before the program is executed, the link set is encoded (operation S40) using the hash values of the protection set, but the protection set can be encoded using the hash values of the link set. When the protection set is encoded before the program is executed, the protection set can be decoded, while, the program is being executed and then the link set can be encoded in order to prevent tampering.

Also, the link set is encoded before the program is executed and is decoded while uploading the program in the memory, and the protection set is encoded, but the link set, encoded before the program is executed, can be uploaded in the memory as it is.

The method of preventing tampering before the program is executed and the method of preventing tampering while the program is being executed according to the exemplary embodiment of the present invention can be written as computer programs. Codes and code segments for accomplishing the exemplary embodiment of the present invention can be easily constructed by programmers skilled in the art to which the present invention pertains. Also, the computer programs are stored in a computer readable media and are read by a computer to be executed. Accordingly, the method of preventing tampering is realized. Examples of the computer readable media include magnetic recording medium, and an optical data storage medium.

The method of preventing tampering according to the exemplary embodiment of the present invention can prevent modulation of a program and a normal execution of the program by a hacker by uploading the program in a memory before the program is executed, sorting the binary executable codes into the link set and the protection set while the program is being executed, and encoding the binary executable codes.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preventing modulation of an executable program, the method comprising:
decoding a header of the executable program and generating information about a plurality of executable codes of the header;
grouping the plurality of executable codes into a first code group and a second code group with reference to the information about the plurality of executable codes;
matching each of the executable codes of the first code group with respective executable codes of the second code group; and
encoding each of the matched executable codes of the second code group using a respective first hash value of each of the plurality of executable codes of the first code group.

2. The method of claim 1, further comprising:
decoding each of the matched executable codes of the second code group using the respective first hash value of each of the plurality of executable codes of the first code group; and
encoding the corresponding executable codes of the first code group using a respective second hash value of each of the plurality of executable codes of the second code group.

3. The method of claim 1, further comprising modifying a symbol string data of the header of the executable program.

4. The method of claim 2, further comprising modifying a symbol string data of the header of the executable program.

5. The method of claim 1, wherein each of the plurality of executable codes of the first code group corresponds with each of the plurality of executable codes of the second code group, respectively.

6. The method of claim 1, wherein the executable codes of the first code group are protected executable codes.

7. A method of preventing modulation of an executable program, the method comprising:
decoding a header of the executable program and generating information about a plurality of executable codes of the header;
sorting the plurality of executable codes into a first code group, which comprises sensitive executable codes, and a second code group, which comprises non-sensitive executable codes, with reference to the information about the plurality of executable codes;
matching each of the plurality of executable codes of the first code group with each of the plurality of executable codes of the second code group;
decoding a first executable code, which is to be executed, from among the plurality of executable codes of the first code group, using a first hash value of a second executable code corresponding to the first executable code; and
encoding the first executable code using the first hash value of the second executable code, after the decoded first executable code has been executed.

8. The method of claim 7, wherein at least one executable code of the plurality of executable codes of the first code group, excluding the first executable code, is encoded using a second hash value of a corresponding executable code of the second code group, while the first executable code is executed.

9. The method of claim 8, wherein the second code group comprises the second executable code.

10. The method of claim 7, wherein the plurality of executable codes of the first code group corresponds with the plurality of executable codes of the second code group, respectively.

11. An apparatus for preventing modulation of an executable program, the apparatus comprising:
a parsing unit which decodes a header of the executable program and generates information about a plurality of executable codes of the header;
a sorting unit which groups the executable codes into a first code group and a second code group with reference to the information about the executable codes;
a matching unit which matches each of the executable codes of the first code group with respective executable codes of the second code group; and
an encoder and decoder which encodes each of the executable codes of the second code group which corresponds to the executable codes of the first code group, respectively, using a first hash value of each of the plurality of executable codes of the first code group.

12. The apparatus of claim 11, wherein the encoder and decoder comprises:
a hash function unit which generates a first hash value corresponding to a first executable code of the first code group; and
a scrambler which operates a second executable code corresponding to the first executable code and the first hash value to output the encoded second executable code.

13. The apparatus of claim 12, wherein the encoder and decoder decodes the corresponding second executable code using the first hash value of the first executable code and encodes the corresponding first executable code using a second hash value of the second executable code.

14. The apparatus of claim 13, wherein the second code group comprises the second executable code.

15. The apparatus of claim 11, further comprising a substituting unit which changes a symbol string data of the header of the executable program.

16. The apparatus of claim 11, wherein each of the plurality of executable codes of the first code group corresponds with each of the plurality of executable codes of the second code group, respectively.

17. The apparatus of claim 11, wherein the executable codes of the first code group are protected executable codes.

18. An apparatus for preventing modulation of an executable program, the apparatus comprising:
a parsing unit which decodes a header of the executable program and generates information about a plurality of executable codes of the header;
a sorting unit which groups the executable codes into a first code group, comprising sensitive executable codes, and a second code group, comprising non-sensitive executable codes, with reference to the information about the plurality of executable codes;
a matching unit which matches each of the plurality of executable codes of the first code group with each of the respective executable codes of the second code group; and
an encoder and decoder which decodes a first executable code, which is to be executed, from among the plurality of executable codes of the first code group, using a first hash value of a second executable code corresponding to the first executable code, and encodes the first executable code using the first hash value of the second executable code, after the decoded first executable code has been executed.

19. The apparatus of claim 18, wherein at least one executable code of the first code group, excluding the first executable code, is encoded using a second hash value of a corresponding executable code of the second code group, while the first executable code is executed.

20. The apparatus of claim 18, wherein the second code group comprises the second executable code.

21. The apparatus of claim 17, wherein each of the plurality of executable codes of the first code group corresponds with each of the plurality of executable codes of the second code group, respectively.

22. A computer readable recording medium having recorded thereon a program for executing a method of preventing modulation of an executable program, the method comprising:
decoding a header of the executable program and generating information about a plurality of executable codes of the header;
grouping the plurality of executable codes into a first code group and a second code group with reference to the information about the plurality of executable codes;
matching each of the plurality of the executable codes of the first code group with respective executable codes of the second code group; and
encoding each of executable codes of the second code group corresponding to each of the executable codes of the first code group using each first hash value of the plurality of executable codes of the first code group.

23. A computer readable recording medium having recorded thereon a program for executing a method of preventing modulation of an executable program, the method comprising:
decoding a header of the executable program and generating information about a plurality of executable codes of the header;
sorting the plurality of executable codes into a first code group, comprising sensitive executable codes, and a second code group, comprising non-sensitive executable codes, with reference to the information about the plurality of executable codes;
matching each of the executable codes of the first code group with respective executable codes of the second code group;
decoding a first executable code, which is to be executed, from among the plurality of executable codes of the first code group, using a first hash value of a second executable code corresponding to the first executable code; and
encoding the first executable code using the first hash value of the second executable code, after the decoded first executable code has been executed.
